(19) United States
(12) Patent Application Publication
(10) Pub. No.: US 2024/0188784 A1
(43) Pub. Date: Jun. 13, 2024

(54) FLOOR-CLEANING SYSTEM, FLOOR-CLEANING APPARATUS, AND METHOD FOR OPERATING A FLOOR-CLEANING SYSTEM OR A FLOOR-CLEANING APPARATUS

(71) Applicant: ALFRED KÄRCHER SE & CO. KG, Winnenden (DE)

(72) Inventors: Heiko HÖNNIGE, Winnenden (DE); Felipe GARCIA LOPEZ, Winnenden (DE); Manuel DRUST, Winnenden (DE); Thilo EHRENTREICH, Winnenden (DE); Fedor VLASOV, Winnenden (DE); Christian HOFNER, München (DE); Gereon HINZ, München (DE)

(21) Appl. No.: 18/444,134

(22) Filed: Feb. 16, 2024

Related U.S. Application Data
(63) Continuation of application No. PCT/EP2021/073077, filed on Aug. 19, 2021.

(51) Int. Cl. A47L 11/40

(52) U.S. Cl. CPC A47L 11/4061; A47L 11/4008; A47L 11/4011; A47L 11/4066; A47L 2201/04; A47L 2201/06

(57) ABSTRACT

The invention relates to a floor cleaning system comprising a self-propelled and self-steering floor cleaning apparatus, at least one controllable display unit, and at least one storage unit, wherein the floor cleaning apparatus comprises a running gear for traveling on a floor surface, a control unit, a sensor unit, at least one cleaning unit, and an operating unit, wherein an environment is detectable by means of the sensor unit in order to locate and/or navigate the floor cleaning apparatus, in particular during movement, wherein cleaning paths for the floor cleaning apparatus are stored in the at least one storage unit with respective information about a route and preferably the use of at least one cleaning unit, wherein a cleaning task is specifiable by a user on the operating unit by linking two or more cleaning paths to be processed successively, and the cleaning task is automatically processable by the floor cleaning apparatus, wherein at least one characteristic landmark that is detectable by means of the sensor unit is stored in the storage unit and is associated with two or more cleaning paths, wherein a start position and/or an end position of a respective cleaning path is located on or at the landmark, and wherein a selection of the cleaning paths associated with the respective landmark is providable to the user on the at least one display unit. The invention further relates to a floor cleaning apparatus and to a method for operating a floor cleaning system or a floor cleaning apparatus.

### CROSS-REFERENCE TO RELATED APPLICATIONS

This application is a continuation application of international application number PCT/EP2021/073077, filed on Aug. 19, 2021, which is incorporated herein by reference in its entirety and for all purposes.

### FIELD OF THE INVENTION

The present invention relates to a floor cleaning system comprising a self-propelled and self-steering floor cleaning apparatus, at least one controllable display unit, and at least one storage unit, wherein the floor cleaning apparatus comprises a running gear for traveling on a floor surface, a control unit, a sensor unit, at least one cleaning unit, and an operating unit, wherein an environment can be detected by means of the sensor unit in order to locate and/or navigate the floor cleaning apparatus, in particular during movement, wherein cleaning paths for the floor cleaning apparatus are stored in the at least one storage unit with respective information about a route and preferably the use of at least one cleaning unit.

Furthermore, the present invention relates to a floor cleaning apparatus of a floor cleaning system of the type described above.

The present invention further relates to a method for controlling a floor cleaning system and a floor cleaning apparatus.

### BACKGROUND OF THE INVENTION

The above-described floor cleaning apparatus allows autonomous performance of a cleaning task. In so doing, the floor cleaning apparatus can be moved on the floor surface in accordance with the information stored in the cleaning path and can clean it. The cleaning path can have information about the route to be covered and in particular the use of at least one cleaning unit. For example, which cleaning unit is activated and the cleaning performance (for example, drive power of a motor and/or metering of a cleaning liquid) with which the floor surface is to be cleaned can be stored.

Floor-cleaning apparatuses are known in which cleaning paths previously traveled by a user are stored in a teach-in operating mode and can then be automatically repeated by the floor cleaning apparatus.

An object underlying the present invention is to provide a floor cleaning system, a floor cleaning apparatus, and a method for operating the floor cleaning system or the floor cleaning apparatus which enables a more user-friendly way of specifying cleaning tasks for the user.

### SUMMARY OF THE INVENTION

In a first aspect of the invention, a floor cleaning system comprises a self-propelled and self-steering floor cleaning apparatus, at least one controllable display unit and at least one storage unit. The floor cleaning apparatus comprises a running gear for traveling on a floor surface, a control unit, a sensor unit, at least one cleaning unit, and an operating unit, An environment can be detected by means of the sensor unit in order to locate and/or navigate the floor cleaning apparatus, in particular during movement, wherein cleaning paths for the floor cleaning apparatus are stored in the at least one storage unit with respective information about a route and preferably the use of at least one cleaning unit. A cleaning task can be specified by a user on the operating unit by linking two or more cleaning paths to be processed successively, and the cleaning task can be automatically processed by the floor cleaning apparatus. At least one characteristic landmark that can be detected by means of the sensor unit is stored in the storage unit and is associated with two or more cleaning paths. A start position and/or an end position of a respective cleaning path is located on or at the landmark, and a selection of the cleaning paths associated with the respective landmark can be provided to the user on the at least one display unit.

In a second aspect of the invention, a floor cleaning apparatus of a floor cleaning system in accordance with the first aspect is provided.

In a third aspect of the invention, a method for operating a floor cleaning system in accordance with the first aspect or a floor cleaning apparatus in accordance with the second aspect is provided, wherein at least one characteristic landmark is stored in the storage unit, to which landmark are associated two or more cleaning paths. A start position and/or an end position of a respective cleaning path is located on or at the landmark, and a cleaning task is specified by a user on the operating unit by linking two or more cleaning paths to be processed successively, and the cleaning task is automatically processed by the floor cleaning apparatus.

### BRIEF DESCRIPTION OF THE DRAWINGS

The foregoing summary and the following description may be better understood in conjunction with the drawing figures, of which:

FIG. 1: shows a perspective representation of a floor cleaning apparatus in accordance with the invention;

FIG. 2: shows a schematic partial representation of a floor cleaning system in accordance with the invention, comprising the floor cleaning apparatus from FIG. 1;

FIG. 3A: shows a schematic representation of a map of the environment of the floor cleaning apparatus from FIG. 1;

FIG. 3B: shows a schematic representation of a map combined from two maps of the environment of the floor cleaning apparatus from FIG. 1;

FIGS. 3C and 3D: show a respective schematic representation of a map of the environment of the floor cleaning apparatus from FIG. 1;

FIG. 3E: shows a schematic representation of a combined map of the environment of the floor cleaning apparatus from FIG. 1;

FIG. 4: shows a view of a display unit of the floor cleaning apparatus with the option of searching for landmarks and cleaning paths;

FIG. 5: shows another representation of the display unit after selecting the marker No. 1 and selecting cleaning paths;

FIG. 6: shows another representation of the display unit with reference to the positioning of the floor cleaning apparatus on a marker;

FIG. 7: shows a representation corresponding to FIG. 6 after detection of the marker by the floor cleaning apparatus;

FIG. 8: shows a schematic representation to illustrate a teach-in of a cleaning path;

FIGS. 9 and 10: show other schematic representations to illustrate the teach-in of a cleaning path; and

FIG. 11: shows a floor cleaning system in accordance with the invention comprising a floor cleaning apparatus in accordance with the invention.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims without departing from the invention.

The present invention relates to a floor cleaning system comprising a self-propelled and self-steering floor cleaning apparatus, at least one controllable display unit, and at least one storage unit, wherein the floor cleaning apparatus comprises a running gear for traveling on a floor surface, a control unit, a sensor unit, at least one cleaning unit, and an operating unit, wherein an environment is detectable by means of the sensor unit in order to locate and/or navigate the floor cleaning apparatus, in particular during movement, wherein cleaning paths for the floor cleaning apparatus are stored in the at least one storage unit with respective information about a route and preferably the use of at least one cleaning unit, wherein a cleaning task is specifiable by a user on the operating unit by linking two or more cleaning paths to be processed successively, and the cleaning task is automatically processable by the floor cleaning apparatus, wherein at least one characteristic landmark that is detectable by means of the sensor unit is stored in the storage unit and is associated with two or more cleaning paths, wherein a start position and/or an end position of a respective cleaning path is located on or at the landmark, and wherein a selection of the cleaning paths associated with the respective landmark is providable to the user on the at least one display unit.

In the floor cleaning system in accordance with the invention, there is the possibility of linking cleaning paths to one another to create a cleaning task. Two or more cleaning paths as a component of the cleaning task can be traversed sequentially by the floor cleaning apparatus, and the floor surface can be cleaned in each case. At least one characteristic landmark is stored in the at least one storage unit for “organization,” so to speak, in order to enable spatial localization of the cleaning paths in the environment of the floor cleaning apparatus. Two or more cleaning paths are associated with the landmark, the respective start position and/or end position of which is located at or near the landmark. Based upon the information provided, the cleaning task can be created in a user-friendly manner. For example, cleaning paths are linked to one another such that an end position of a first cleaning path and a start position of the next cleaning path are at the same landmark. It is preferably possible to create complex cleaning tasks across a plurality of optionally present landmarks, for example, across several rooms or even stories if they can be traveled on. The spatial relationship of the at least one landmark to the cleaning paths preferably ensures correct navigation and/or localization of the floor cleaning apparatus, since repeated position adjustment is possible.

In the present case, “at the landmark” can in particular be understood as “in the immediate vicinity” of the landmark. “In the immediate vicinity” can be defined, for example, by a specified or specifiable distance, for example, a radius of approximately 5 m around the landmark. All that is required is that the landmark can be detected by the sensor unit, and, based upon this, it can be determined by the floor cleaning apparatus that the floor cleaning apparatus is located on or at the landmark.

The operation of the floor cleaning apparatus is controlled in particular by the control unit, which can be in operative connection with the sensor unit and controls the running gear. The control unit can be coupled to the at least one display unit, the at least one storage unit, and the at least one cleaning unit.

In particular, it can be provided that two or more characteristic landmarks that can be detected by means of the sensor unit be stored in the storage unit, wherein two or more cleaning paths are associated with at least one landmark, and at least one cleaning path is associated with each landmark. A start position and/or an end position of a respective cleaning path can be located at the respective landmark. A selection of the cleaning paths associated with the respective landmark can preferably be provided to the user on the at least one display unit. In this embodiment, the cleaning paths of different landmarks can be combined in a user-friendly manner into a cleaning task. It is conceivable in this case in particular, as will be discussed below, that a cleaning path lead from one landmark to another landmark different therefrom.

In accordance with the above, several landmarks can be stored in the storage unit. The respective landmarks can, for example, be indicative of at least one of the following: exactly one room of an environment, at least one room of an environment, a section within a room of the environment, or a story. In the latter case, for example, for each story, a landmark can be provided for the identification of the story. It is conceivable that the floor cleaning apparatus be able to preferably automatically approach different stories via at least one ramp and/or at least one elevator. The respective story-related landmarks are, for example, connected to one another via a transport path without cleaning (for example, by travel with the elevator), wherein the use of a cleaning path is also conceivable, for example, when traveling on a ramp.

It is advantageous if the floor cleaning system comprises at least one landmark which is preferably configured as a marker element which can be detected visually and/or electrically and/or electromagnetically by the sensor unit. It has been shown in practice that the use of an artificial marker element proves to be reliable for detection by the sensor unit. In this case, unique marker elements are preferably used which can be clearly identified as such by the floor cleaning apparatus.

With regard to a visual design of the sensor unit, it has proven to be particularly advantageous if the marker element is optically detectable.

For example, the marker element is a matrix code (e.g., an ArUco marker element) or a barcode.

Preferably, when there are a plurality of landmarks, all landmarks are “artificial” marker elements as described above.

It can be provided that at least one characteristic feature of an environment of the floor cleaning apparatus be able to be used as a landmark. For example, this can be a distinctive feature of a room in which the floor cleaning apparatus is located. Such features are, for example, boundaries of the room or objects in the room.

The cleaning task can preferably be stored, and in particular changeably stored, in the at least one storage unit. The stored cleaning task can be repeatedly retrieved and processed by the user.

The at least one landmark can, for example, be stored in a map of the environment.

It may be provided that a map of the environment be stored in the storage unit associated with at least one landmark, in which map the cleaning paths associated with the landmark are stored. In the present case, this can be understood in particular as meaning that the position of the landmark within the map is stored, and also the association of cleaning paths with this landmark, wherein travel routes do not necessarily have to be displayed visually in the local map. The use of the map allows the complexity of a representation of the environment in the storage unit to be minimized. The landmark forms, so to speak, an “anchor point” in the map for the at least one cleaning path associated with the landmark. Navigation and/or localization within the environment is facilitated by the map.

When there are a plurality of landmarks, a plurality of maps can be provided in which a respective landmark is stored with one or more cleaning paths associated with this landmark.

It can be provided that cleaning paths and/or transport paths running between different landmarks link the respective maps to one another. In this way, maps can be joined together like puzzle pieces, so to speak, to form a combined map. Cleaning paths and/or transport paths across the individual maps can thereby be stored in the combined map.

It can be provided that a combined map be stored in the storage unit, in which map at least one landmark and the cleaning paths associated with this landmark are stored. In this way, the system detects information as comprehensive as possible about the environment.

Two or more landmarks and the cleaning paths associated with these landmarks are, conveniently, stored in the combined map.

It can be provided that all landmarks be stored in the combined map.

Cleaning paths can be provided and associated with the at least one landmark and can have a start position and an end position at the landmark.

Alternatively or additionally, cleaning paths can be provided which have a start position at one landmark and an end position at another landmark. In the latter case, for example, cleaning tasks can be defined across two or even more landmarks.

It can be provided that a cleaning path or a transport path always start at a landmark and always end at a landmark, but not necessarily at the same landmark.

Maps can be combined, for example, if a cleaning path or a transport path runs between landmarks, at least one of which is stored in two maps.

Alternatively or additionally, a combination of maps may be possible, for example, if at least a part of the environmental features corresponds within the respective maps (hereafter also referred to as “visible areas”). This may preferably also be possible without a landmark which is stored in two or more maps and can be used as an “anchor point.”

The landmark and/or the cleaning path can be selected, for example, by touching within a representation of the map. For example, if a landmark is selected, cleaning paths and/or transport paths associated with the landmark can be displayed. Preferably, both respective landmarks are displayed for paths running between different landmarks.

In particular, it can also be provided that the representation of the cleaning path directly, or after prior selection of the cleaning path by a user, comprise information about at least one landmark which is associated with the cleaning path.

The floor cleaning apparatus can be operated manually by a user.

For example, it can be provided that the floor cleaning apparatus be able to be guided by the user from a current start position to a landmark, starting from which the cleaning task is initiated. The current start position is, for example, the location at which the cleaning task is created.

It can be provided that the floor cleaning apparatus be able to be guided by the user from a landmark to a parking position after completion of the cleaning task.

It can be provided that the floor cleaning apparatus be able to be guided by the user from a first landmark at which a cleaning path ends up to another landmark at which another cleaning path begins. Accordingly, it can be provided that runs between different landmarks be made by the user and not by the floor cleaning apparatus itself.

It can be provided that the floor cleaning apparatus automatically move from a current start position to a landmark from which the cleaning task is initiated.

It can be provided that the floor cleaning apparatus automatically move from a landmark to a parking position after completion of the cleaning task.

It can prove advantageous if the floor cleaning apparatus, when processing the cleaning task, moves from a first landmark at which a cleaning task ends to another landmark at which another cleaning path begins. Such an empty run or transport run can be carried out automatically by the floor cleaning apparatus in particular.

The possibility of providing a transport path has already been discussed.

It can be advantageous if, in the at least one storage unit, at least one transport path is stored linked to at least one landmark without using the at least one cleaning unit, which landmark can be specified by the user in particular as a component of the cleaning task. The transport path serves, for example, to pass through regions of the environment without cleaning in order to reach a second cleaning path from a first cleaning path.

The transport path extends, for example, from a current start position to a landmark from which the cleaning task can be carried out.

The transport path extends, for example, from a landmark at which a cleaning path or the cleaning task ends up to a parking position.

The transport path extends, for example, from a first landmark at which a cleaning path ends up to another landmark at which another cleaning path begins. In this case, the transport path can be used in particular for the empty run between landmarks within the cleaning task.

At least one display unit can be a touch-sensitive display unit. For example, a touchscreen is used here for receiving entries from the user. This makes it possible, for example, to select displayed cleaning paths in order to create the cleaning task.

The display unit preferably at least partially forms the operating unit, for example, with the above-described touchscreen.

With regard to user-friendly handling, it is advantageous if a graphical user interface can be provided to the user on the display unit for seeking a stored landmark and/or a stored cleaning path. For example, each landmark and/or each cleaning path can have a characteristic designation to make it easier for the user to seek the designation.

For example, when using a touchscreen, the graphical user interface can comprise common input elements such as text fields, selection lists, icons, pictograms, virtual buttons (softkeys), or the like.

A voice control of the floor cleaning apparatus, in particular, for seeking cleaning paths, landmarks, and/or creating cleaning tasks, can also be provided.

It can be provided that a map of the environment be able to be displayed to the user on the display unit for selecting a landmark and/or a stored cleaning path shown therein. For example, the map can be a “simple” map or a combined map as explained above.

During a teach-in process, the user can preferably be supported by the floor cleaning apparatus in the guidance thereof. For example, a notification is issued if the user comes too close to an obstacle or a boundary of the floor surface, and thereby makes steering maneuvers more difficult or impossible.

Advantageously, a graphical user interface can be provided to the user on the display unit to represent a landmark and/or a stored cleaning path, in particular, depending upon a preceding search. The landmark and/or the cleaning path are represented, for example, by text information or by a virtual button (for example, as an icon) and can preferably be selected by the user.

Preferably, cleaning paths can be selected on the user interface using names and/or icons and can be shown in a manner linkable to the cleaning task. It can be provided, for example, that the cleaning task be created by successive selection of cleaning paths. The representation of the respective cleaning path can comprise, for example, its name and preferably graphical information about the course of the path.

The cleaning paths can preferably be displayed linked to a selected landmark. For example, after selecting or seeking a landmark, those cleaning paths that are associated with this landmark are displayed.

It can be provided, for example, that cleaning paths not associated with the landmark be hidden or be shown as not selectable. In the latter case, the cleaning paths are shown, for example, but are not provided for selection. Operation is made easier for the user by limiting the possible selection to those cleaning paths that are assigned to the landmark.

When a cleaning path is selected on the display unit, information about at least one further cleaning path can be provided, for example, which begins at the end position of the selected cleaning path or at the end position of which the selected cleaning path begins. This makes it easier for the user to link cleaning paths to the cleaning task.

It may be provided that the at least one cleaning path be able to be created externally to the floor cleaning apparatus by a user at a data processing apparatus and stored in the storage unit.

It can be advantageous if the floor cleaning apparatus is designed and configured to create and store at least one cleaning path on the operating unit, under the guidance of the user, in a teach-in operating mode. During the teach-in, the user guides the floor cleaning apparatus along the desired route and adjusts the at least one cleaning unit—possibly in different ways, in accordance with the desired cleaning. This information can be stored in the cleaning path and repeated during processing.

An adaptation of the cleaning path, for example, of the route, after the creation thereof, can be provided. In this case, optimization is conceivable, for example, with regard to area coverage, kinematic boundary conditions, collision avoidance to maintain edge proximity, safety requirements, and/or with regard to the best possible cleaning result. For example, implausible and redundant movements are eliminated during the teach-in.

In teach-in operating mode, it can be provided that a section of the floor surface recognized by the floor cleaning apparatus and/or a section of the floor surface traversed by the user along a circumference be able to be automatically assigned a route of the cleaning path and, in particular, be able to be assigned so as to cover the entire area. Such sections, for example, free areas, do not have to be completely traversed by the user during the teach-in. For example, the free area is detected by the floor cleaning apparatus itself per se, or the user moves the floor cleaning apparatus along a circumference of the free area. The route can be automatically fixed by the floor cleaning apparatus to fill the free area.

The free area can optionally comprise at least one obstacle, the position of which can be taken into account when determining the route. The area boundaries of the section can be closed automatically, for example, by the user linking a start instruction and an end instruction.

When the section of the floor surface is covered with a route, the floor cleaning apparatus can advantageously determine which size (for example, in square meters) the section has.

Based in particular upon the latter information, it is advantageous if, for example, the user can be provided with a notification on the at least one display unit as to the quantity of a consumable component (for example, electrical energy and/or cleaning fluid) required to clean the section. The user can take this information into account for the planning of cleaning tasks to ensure that a sufficient supply of the consumable component is carried to perform the cleaning task. Alternatively or additionally, a notification can be provided as to whether the quantity of an existing consumable component carried by the floor cleaning apparatus is sufficient to clean the section. For example, the user can be informed that the carried quantity is not sufficient, and the consumable component should be refilled before processing the cleaning task.

In particular in the advantageous embodiments of the preceding paragraph, it can be advantageous if the floor cleaning apparatus determines the amount of the at least one consumable component based upon a previous actual consumption during the cleaning path. The determination can take place, for example, by direct measurement of consumption, and/or relative to a maximum supply of the consumable component (for example, a fully-charged battery or full supply of cleaning liquid).

The determination can be carried out, for example, taking into account a model value, which, for example, can be a standard consumption, a resource-saving eco consumption, an intensive consumption with high cleaning performance, or the like of a cleaning process.

For example, by means of the model value, a prediction can be made by the floor cleaning apparatus about an area that can still be cleaned with an existing supply of a consumable component. (Calculation example: maximum supply minus actual consumption=existing supply; on this basis, the area that can still be cleaned can be determined based upon the model value, e.g., at a typical cleaning speed).

Accordingly, it can be advantageous if the floor cleaning apparatus determines a still possible cleaning route (e.g., in meters) or the size of an area still to be cleaned (e.g., in square meters) based upon the model value and a supply of the at least one consumable component during the teach-in, and provides the user with information about this on the at least one display unit.

It can be provided that the floor cleaning apparatus provide a notification to the user during the teach-in that a section of the floor surface that he detected using the sensor unit can be automatically assigned a route.

The cleaning path can preferably not be limited solely to routes of the floor cleaning apparatus across the floor surface in which at least one cleaning unit is activated.

For example, the cleaning path can have one or more segments, wherein at least one cleaning unit is activated on at least one segment, wherein at least one of the following also applies to the cleaning path:
Different types of cleaning units are activated or deactivated at different segments of the cleaning path or within a segment. For example, the floor surface can be cleaned at different positions—for example, along different segments or within different sections of a segment—in different ways. In this case, different cleaning units can be activated in each case, for example, a floor cleaning head, a side brush, or a squeegee in the case of a scrubber vacuum.
There is at least one segment in which no cleaning unit is activated. Within a cleaning path, for example, a transport segment can be provided, without cleaning the floor surface, in which the cleaning units are activated or at least switched in such a way that the floor surface is not acted upon by the cleaning unit.
Paths and assignable sections of the floor surface are stored in the cleaning path, for example, the sections of the floor surface described above and automatically assignable with color (this can be referred to, for example, as a fill-in segment). For example, it is stored in the cleaning path that a specific segment is a fill-in segment.
At least one interaction of the floor cleaning apparatus with the environment is stored in the cleaning path. In the present case, this can be understood in particular as meaning that the floor cleaning apparatus can in particular interact with persons in the environment. The interaction event is, for example, an acoustic and/or visual notification to be output by the floor cleaning apparatus. By means of the notification, persons can be made aware of the floor cleaning apparatus.

In the teach-in of cleaning paths, the above-described segments within a cleaning path can preferably be connected to one another as desired by a user. Interaction events can also be stored, such as paths and assignable sections of the floor surface. Furthermore, it is understood that transport segments, or segments, or sections of a segment in which different cleaning units are activated can be stored in the cleaning path.

In the teach-in, the user can preferably, in teach-in operating mode, issue specifications to the operating unit. For example, the activation of a cleaning unit yields a cleaning segment, a run when the cleaning unit is deactivated yields a transport segment, and/or a fill-in specification yields a fill-in segment. Depending upon the specification, the different types of segments can be created by the floor cleaning apparatus, preferably in the cleaning path—for example, a transport segment, a cleaning segment (without fill-in), a fill-in segment, a cleaning segment (without fill-in), a fill-in segment, a transport segment, etc., or other types of combinations of segments, in each case taught via a teach-in. Any type of segment could be taught in this way in a cleaning path, optionally with at least one interaction event. In this case, the segments are preferably connected to one another based upon the specification of the user for the cleaning path, in particular, without active intervention or linking by the user.

Given the above advantageous embodiments, the floor cleaning system turns out to be particularly versatile. Within a cleaning path, different driving and/or operating modes and/or events can thus preferably be combined as desired without having to create a separate cleaning path for this purpose. This also proves to be advantageous with respect to handling in view of the fact that the otherwise complex management of a high number of paths can be avoided.

The above-mentioned path properties can preferably be defined both by the teach-in and by externally defining the cleaning path outside the floor cleaning apparatus.

In the method for the floor cleaning apparatus, a notification can preferably be output to the user on the at least one display unit to position the floor cleaning apparatus at a landmark in such a way that the landmark can be recognized by means of the sensor unit. This is used, for example, to ensure a correct start position upon the initiation of the cleaning task.

In the event that the landmark is detected, for example, the processing of a cleaning task beginning at the landmark can be triggered.

In the event that at least one landmark is detected, information about the cleaning paths associated therewith can preferably be displayed on the display unit—preferably for creating the cleaning task. For example, when a landmark is detected, the floor cleaning apparatus automatically provides the user with suitable cleaning paths that are linked to the landmark.

When the floor cleaning apparatus is guided by the user, a notification about the cleaning paths associated with the landmark can advantageously be provided on the display unit when at least one landmark is detected by the sensor unit.

It is advantageous if the floor cleaning system comprises at least one docking station for the floor cleaning apparatus to assume a defined position in a docking position. In a simple embodiment, the docking station can be a parking station at which the floor cleaning apparatus is parked or, in the automatic method, stops. The “docking” can in particular take place contact-free in a parking station and requires no physical contact between the docking station and the floor cleaning apparatus.

It is advantageous if the at least one docking station comprises or forms a landmark. In particular, the above-described marker element is arranged at the docking station or is formed thereby.

At least one consumable component required for processing the cleaning task can preferably be supplied to the floor cleaning apparatus by the at least one docking station, for example, electrical energy and/or a cleaning liquid. The consumable component can also be referred to as a resource.

Preferably, a used component of the floor cleaning apparatus can be picked up by the at least one docking station, for example, dirty liquid picked up from the floor surface.

It goes without saying that the docking station and the floor cleaning apparatus can comprise corresponding connection elements, which couple in the docking position, to fulfill the tasks described above. This is known to a person skilled in the art.

It can advantageously be provided that the floor cleaning apparatus be designed such that, at a respective docking station, at least one usable component is supplied in a sufficient amount for an upcoming cleaning path, and/or, if necessary, a used component is removed. In this way, it is ensured that sufficient resources are available for a cleaning path to be processed, and/or used resources are removed from the floor cleaning apparatus.

The floor cleaning apparatus is advantageously designed such that, while processing the cleaning task, the at least one docking station can be visited in the event that the processing requires the supply of at least one consumable component and/or the discharge of at least one consumable component. It is conceivable, for example, that, before the start of the cleaning task or during the processing by the floor cleaning apparatus, it be automatically checked whether the required consumable components are sufficient or should be supplied. The same applies to the removal of the used component. The check can take place, for example, during the processing of a cleaning path. If necessary, the processing thereof is interrupted. The check can occur between successive cleaning paths so that the floor cleaning apparatus begins a new cleaning path only when components have been replenished or removed.

If necessary, the floor cleaning apparatus can deviate from a predetermined route in order to go to a docking station.

It can be advantageous if the at least one docking station can be headed for in the cleaning path in accordance with a specification in order to supply at least one consumable component and/or to discharge at least one used component. Already during the teach-in or during the external planning of the cleaning path, the user can plan required resources and store this in the cleaning path and/or in the cleaning task.

Preferably, the floor cleaning apparatus is designed such that, during the processing of the cleaning task, depending upon a remainder of the cleaning task still to be processed, it automatically determines a quantity of a consumable component required for this purpose and, if necessary, picks it up at at least one docking station and/or discharges a consumed component, wherein picking up too much consumable component is preferably avoided. In this way, cleaning tasks can, for example, be processed reliably, and preferably in a time-saving manner. If the floor cleaning apparatus determines, for example, that a consumable component is required, it can be picked up. In this case, only as much of the consumable component is, advantageously, picked up for the cleaning path and/or the cleaning task to be processable, but picking up too much is avoided. The cleaning can thereby be continued as quickly as possible, and unnecessary downtime at the docking station can be kept short. A sufficient buffer is advantageously provided for the consumable component so that the cleaning task can be reliably finished.

It can be provided that supplying and/or removing consumable/consumed components at at least one docking station before picking up and/or after ending be stored in the cleaning path.

It may be provided for the floor cleaning apparatus to comprise at least one storage unit. In this way, cleaning paths can be stored locally in the floor cleaning apparatus.

In a preferred embodiment of the invention, it may be provided for at least one storage unit to be positioned remote from the floor cleaning apparatus, wherein information that is to be stored or is stored can be transmitted from the floor cleaning apparatus to the storage unit and/or vice versa via a communications unit. For example, storing in a manner that is remote from the floor cleaning apparatus allows for having cleaning paths covered by different floor cleaning apparatuses in a technically simple manner, wherein, for this purpose, the cleaning paths do not have to be stored in multiple floor cleaning apparatuses. This is advantageous, for example, when changing between floor cleaning apparatuses or in case of floor cleaning apparatus maintenance and/or malfunctions.

It may be provided for the floor cleaning apparatus to comprise at least one display unit which is preferably arranged on the operating unit and may, for example, form part of the operating unit or the operating unit as a whole.

In a preferred embodiment of the invention, it may be provided for at least one display unit to be positioned remote from the floor cleaning apparatus, wherein image information can be transmitted from the floor cleaning apparatus to the display unit via a communications unit. In this way, it is possible to create the cleaning task and/or cleaning paths in a spatially remote control room.

For example, the floor cleaning system comprises a data processing device which has the display unit. The data processing device may be designed centrally or in a spatially distributed manner, for example, via a cloud service.

It may be provided for the floor cleaning system to comprise a (central and/or cloud service) data processing device which has the storage unit.

In a preferred embodiment of the invention, the floor cleaning apparatus may be designed as a scrubber vacuum. Alternatively, the floor cleaning apparatus can, for example, be a vacuum device for dry cleaning the floor surface.

The invention also relates to a floor cleaning apparatus in accordance with the invention which is a floor cleaning apparatus of a floor cleaning system of the type described above. Advantageous embodiments of the floor cleaning apparatus in accordance with the invention result from the above explanations.

The floor cleaning apparatus can in particular form the floor cleaning system.

As mentioned at the outset, the present invention also relates to a method. A method in accordance with the invention for operating a floor cleaning system or floor cleaning apparatus achieves the object posed at the outset in that the floor cleaning system or a floor cleaning apparatus of the type described above is used, wherein at least one characteristic landmark is stored in the storage unit, to which landmark are associated two or more cleaning paths, wherein a start position and/or an end position of the one respective cleaning path is located on or at the landmark, and wherein a cleaning is specified by a user on the operating unit by linking two or more cleaning paths to be processed successively, and the cleaning task is automatically processed by the floor cleaning apparatus.

Advantageous exemplary embodiments of the method follow from advantageous embodiments of the floor cleaning system and/or floor cleaning apparatus in accordance with the invention.

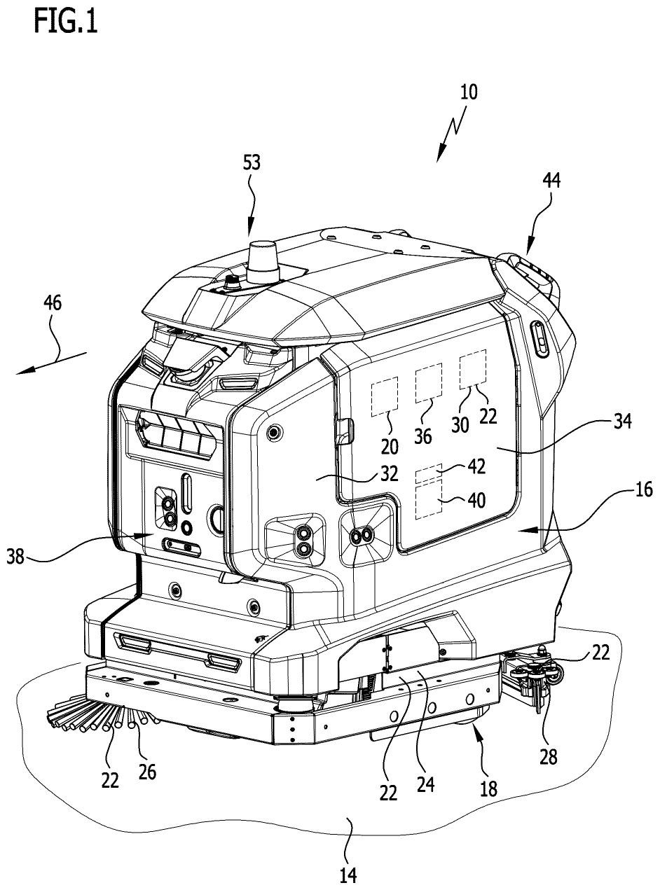

FIG. 1 shows an advantageous embodiment of a floor cleaning apparatus according with the invention, which is denoted overall by the reference numeral 10. The floor cleaning apparatus 10 on its own can form a floor cleaning system in accordance with the invention in a preferred embodiment, without any further components thereof.

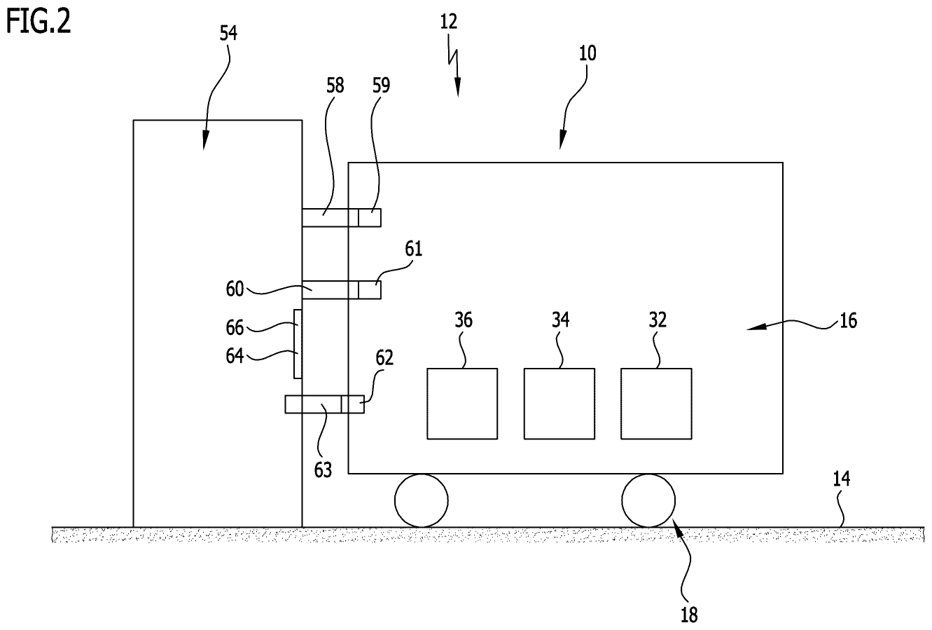

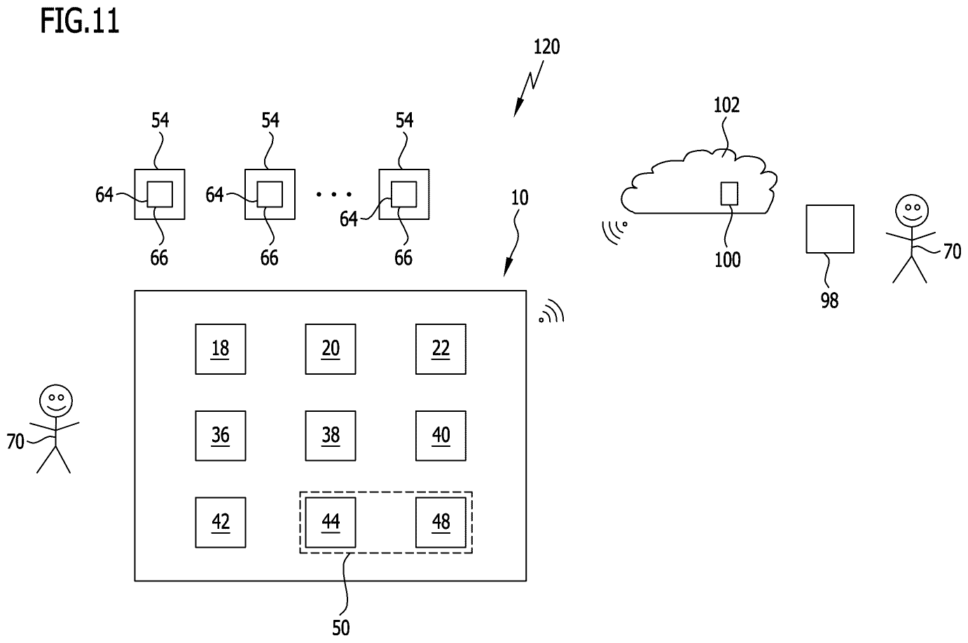

Alternatively or additionally, the floor cleaning apparatus 10 can be a component of another floor cleaning system 12 in accordance with the invention shown schematically in FIG. 2, and/or a floor cleaning system 120 in accordance with the invention shown schematically in FIG. 11 in a preferred embodiment.

The floor cleaning apparatus 10 is designed to be self-propelled and self-steering and, in particular, forms a cleaning robot. Autonomous cleaning of a floor surface 14 can be carried out with the floor cleaning apparatus 10. With the floor cleaning apparatus 10, it is possible, in particular, to cover cleaning paths previously stored and to clean the floor surface 14. The cleaning paths can be taught-in or specified in a teach-in mode of operation (teach-in).

Reference is made to the above statements regarding optional, preferred components of the cleaning path, in particular, segments with or without an activated cleaning unit, different activated cleaning units, and/or interaction events.

As follows in particular from FIGS. 1, 2, and 11, the floor cleaning apparatus 10 comprises a housing 16 with a running gear 18 arranged underneath.

Position and orientation information relates to an intended use of the floor cleaning apparatus 10, in which it can stand on the floor surface 14 via the running gear 18.

The floor cleaning apparatus 10 comprises a control unit 20 for controlling all processes. The floor cleaning apparatus 10 comprises cleaning units 22 for cleaning the floor surface 14. In the present example, the cleaning units 22 comprise a floor cleaning head 24 with roller brushes (not shown in the drawing), a side broom 26, a suction strip 28, and a suction unit 30 for applying negative pressure to the suction strip 28.

The floor cleaning apparatus 10 comprises a storage container 36 for a cleaning liquid, in particular, water. The floor surface 14 is wetted with the mixture of water and, if applicable, a cleaning chemical. The dirt is removed by the cleaning units 22 and transferred to a waste fluid container 34 via the suction strip 28 and under the effect of the suction unit 30.

The floor cleaning apparatus 10 comprises a rechargeable, and in particular electrical, battery 36 for power supply. The cleaning liquid and the electrical energy are consumable components or resources of the floor cleaning apparatus. A used component is the dirty liquid picked up from the floor surface 14.

The floor cleaning apparatus 10 further comprises a sensor unit 38 which may comprise, for example, at least one stereo camera system, a lidar system, and/or an ultrasound system. The control unit 20 can localize and/or navigate the floor cleaning apparatus 10 in its environment on the basis of at least one signal of the sensor unit 38.

The floor cleaning apparatus 10 further comprises a storage unit 40. In particular, characteristic landmarks and cleaning paths can be stored in the storage unit 40.

The floor cleaning apparatus 10 can also comprise a communications unit 42 via which information can be transmitted in a wireless and/or wired manner from the floor cleaning apparatus 10 and to the floor cleaning apparatus 10.

The floor cleaning apparatus 10 moreover has an operating unit 44 which, in relation to a forward direction 46, is arranged on the rear side. A controllable display unit 48 is provided which may be part of, or may at least partially form, the operating unit 44. This is schematically indicated by a dashed line 50 in FIG. 11.

In the present case, the display unit 48 is designed to be touch-sensitive, and in particular a touchscreen 52 with image display, which is preferably colored. The touchscreen 52 allows the reception of entries from the user via a graphical user interface with familiar text fields or buttons (softkeys).

The floor cleaning apparatus 10 can have a notification unit 53 which is designed to be visual and/or audible, for example. For example, a loudspeaker or a horn is provided, and/or a flashing light or a headlight. An interaction event can be output by the notification unit 53 in order to make persons in the environment aware of the floor cleaning apparatus 10.

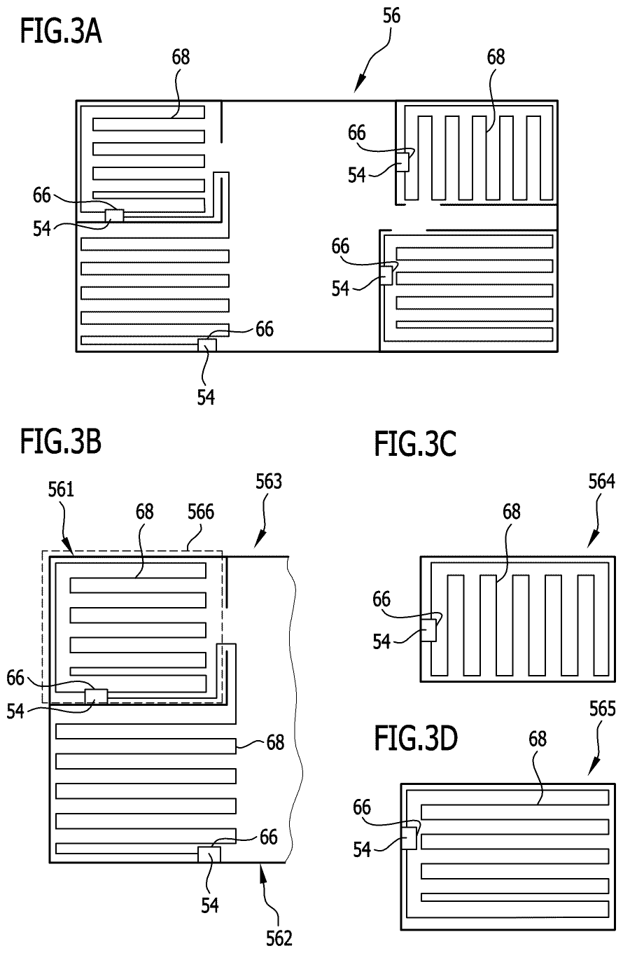

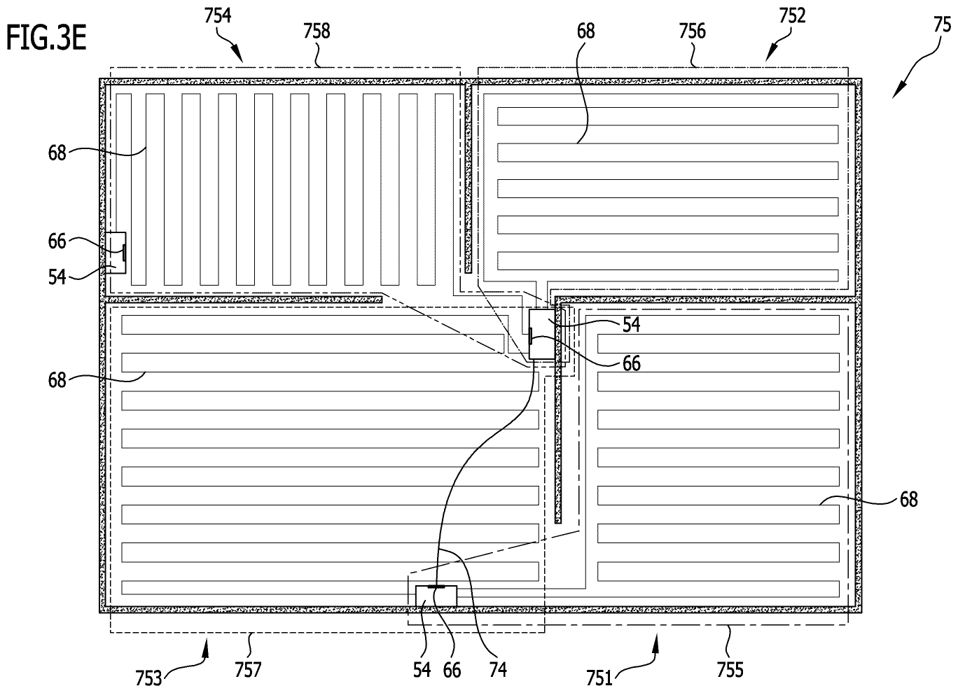

The floor cleaning system 12 comprises at least one docking station 54, and preferably a plurality of docking stations. For example, FIG. 3A shows four docking stations in a total map 56 of the environment of the floor cleaning apparatus 10.

The floor cleaning apparatus 10 can assume a docking position at a respective docking station 54 and thereby has a defined position relative thereto and within the environment.

Electrical energy and cleaning liquid can be supplied as a consumable component via the docking station 54 when the floor cleaning apparatus 10 assumes the docking position. For this purpose, connection elements 58, 59 of the docking station 54 and the floor cleaning apparatus 10 couple to charge the battery 36 with electrical energy. In a corresponding manner, connection elements 60 and 61 of the floor cleaning apparatus 10 and the docking station 54 are coupled to feed the cleaning liquid into the storage container 32.

As a used component, dirty liquid can be discharged and disposed of via connection elements 62, 63 of the floor cleaning apparatus 10 and the docking station 54.

The floor cleaning system 12 comprises characteristic landmarks 64 which are used with the floor cleaning apparatus 10 and the floor cleaning system 12.

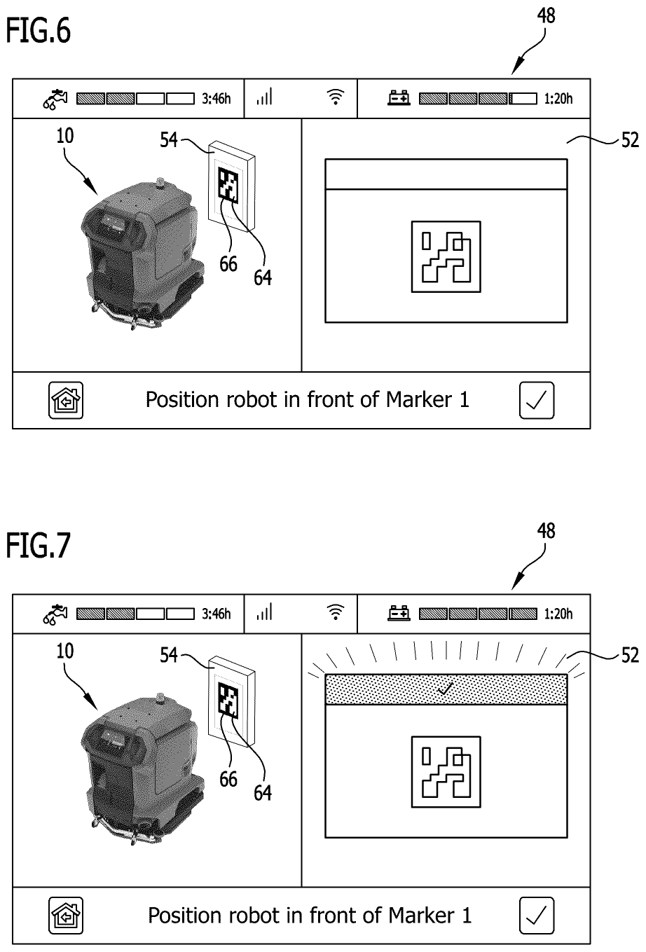

In the present embodiment, a respective docking station 54 comprises a characteristic landmark 64. In the present example, the characteristic landmark 64 is designed as a marker element 66 (FIGS. 6 and 7), which is arranged on a side, facing the floor cleaning apparatus 10, of the docking station 54, and of which it is comprised.

In the present preferred embodiments, it is assumed that the respective docking station 54 comprises or forms a landmark 64, for example, configured by the marker element 66.

However, as explained above, this is only optional. Landmarks 64 can be provided independently of a docking station 54. A mixed case is also possible.

A combination of a landmark 64 with a docking station 54 can, for example, be infrastructure-bound and used where, for example, a docking station 54 can be set up.

In FIGS. 3A through 3E, it is assumed that marker elements 66 are comprised by the docking stations 54. In a departure from this, it could be provided that at least one landmark 64 be used, for example, a marker element 66 which is not comprised by a docking station 54.

At least one docking station 54 can be provided which, as mentioned above, serves to park the floor cleaning apparatus 10 in a parking position, wherein supplying and/or disposing of a resource is not possible.

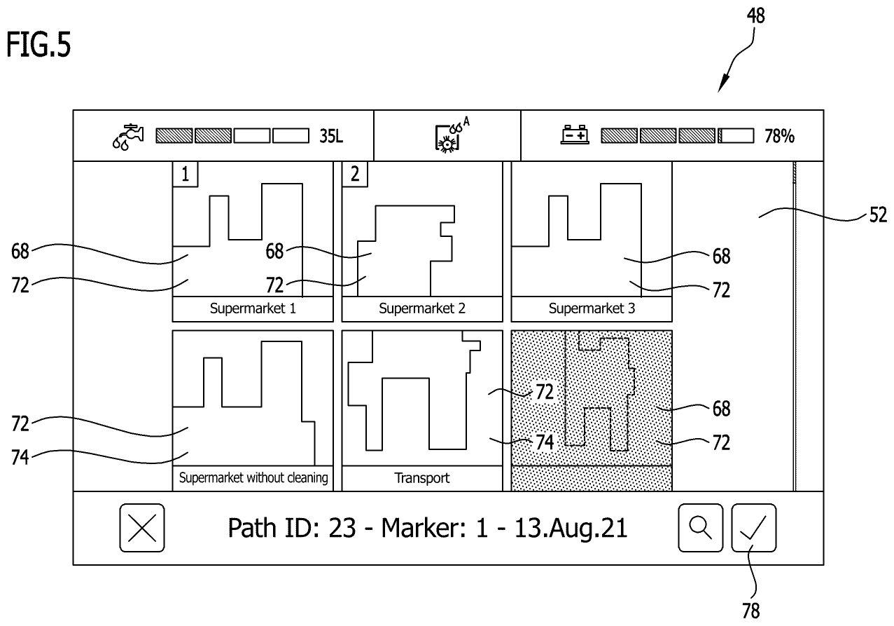

In the present case, the marker element 66, referred to in FIGS. 5 through 7 of the display unit 48 as a “marker,” is optically detectable by the sensor unit 38. In the present example, the marker element 66 is a matrix code, for example, an ArUco matrix code.

The marker elements 66 are unique, so that the floor cleaning apparatus 10 can make a clear statement as to which docking station 54 is involved upon detecting the respective marker element 66. The marker elements 66 are stored in the map 56 alone or in combination with the docking station 54. The position of the respective marker element 66 is stored in the map 56 (directly or indirectly).

In the present case, the map 56 in accordance with FIG. 3A represents the overall environment of the floor cleaning apparatus 10.

In this case, four docking stations 54 are provided by way of example which are arranged in different regions of the environment. Each docking station 54 has a clearly identifiable marker element 66 and thereby in each case forms a characteristic landmark 64.

The map 56 comprises a total of four individual maps 561, 562, 564, and 565 which are shown in FIGS. 3B through 3D.

The maps 561 and 562 can in turn be combined into a combined map 563 in accordance with FIG. 3B. A dashed line 566 in FIG. 3B indicates the perimeter of the map 561. Deviating from the illustration, however, the border of the map 561, as in FIGS. 3C and 3D, runs along the boundaries of the floor surface. In the present case, the offset of line 566 in relation to these boundaries serves only to recognizably identify map 561.

A respective map 561, 563, 564, and 565 shows an environment of at least one marker element 66.

The floor cleaning apparatus 10 is able to navigate autonomously within the environment. One of the maps 56, 561 through 565 can be used here. A position within the environment, which the floor cleaning apparatus 10 can identify in the respective map 56, 561 through 565, allows the linkage between the respective map and the environment. This applies in particular to the marker elements 66 and the docking stations 54, the positions of which are known within the respective map 56, 561 through 565.

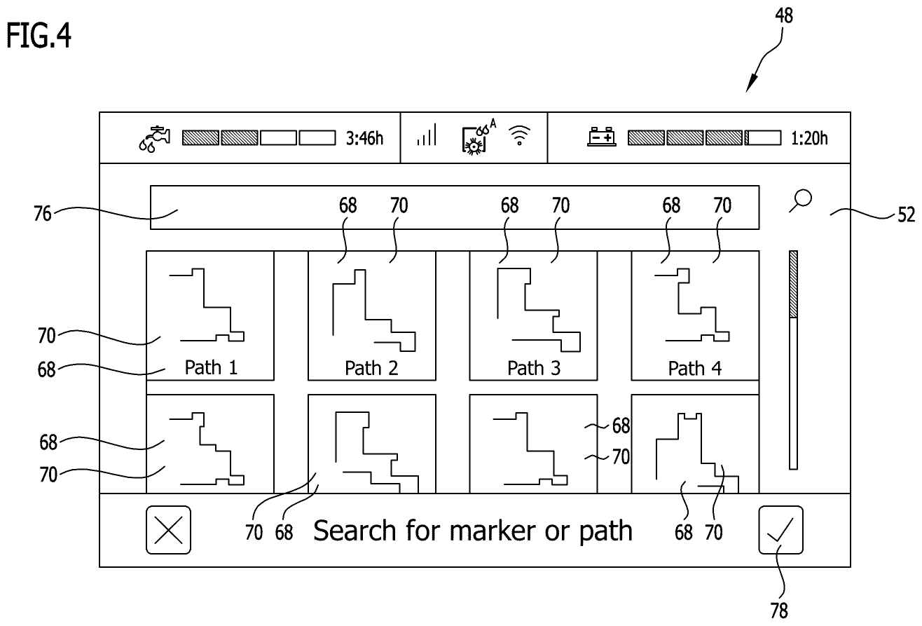

As already mentioned, cleaning paths which have previously been stored in the storage unit 40 can be processed by the floor cleaning apparatus 10, and the floor surface 14 can be cleaned. FIGS. 4 and 5 schematically show cleaning paths 68. It is to be understood in the present case that symbols 72, which are each linked to a stored cleaning path 68, can be displayed to the user 70 on the display unit 48 (FIG. 11).

The cleaning path 68 comprises information about the route of the floor cleaning apparatus 10 and preferably about the use of at least one cleaning unit 22.

In addition, a transport path 74 (FIG. 5) can be stored in the storage unit 40, for example. The transport path 74 can also be displayed, for example, by a symbol 72. The route is stored in the transport path 74, for example. However, no cleaning is provided, so that no information about the cleaning units 22 is stored, or, alternatively, the information that no cleaning unit 22 is in operation.

In accordance with the present invention, the cleaning paths 68 are associated with the marker elements 66, wherein the association is stored in the storage unit 40. As a result, it is known at what marker element 66 the start position and/or the end position of which cleaning path 68 is located.

In this case, it can be provided that the cleaning path 68 start and end at the same marker element 66. Alternatively, it can be provided, for example, that the cleaning path 68 begin at a marker element 66 and end at another marker element 66 different therefrom.

FIGS. 3A through 3D show exemplary representations of the two cases mentioned above. For example, a cleaning path 68 is shown in the maps 561, 564, and 565 starting from a marker element 66 of the docking station 54. In this case, the start position and the end position are each located at the marker element 66 of the docking station 54.

In contrast, two docking stations 54 are stored in the map 562. A cleaning path 68 has its start position at the marker element 66 of the docking station 54 shown above in the drawing, and its end position at the marker element 66 of the docking station 54 shown below in the drawing, or vice versa. This cleaning path 68 therefore runs between different marker elements 66.

The maps 561, 562 can be combined into the combined map 563 in that the upper docking station 54 in the drawing serves somewhat as an “anchor point,” by means of which the linking of the maps 561 and 562 is clearly defined. The anchor points facilitate the combination. As already mentioned, a combination can preferably also be possible if at least a part of the environmental features corresponds within the respective maps (visible areas).

Due to the finite field of view and range of the sensor unit 38, the map 562 is open on the right.

FIG. 3E shows a combined map 75 which is combined from a first map 751, a second map 752, a third map 753, and a fourth map 784. The dashed or dash-dotted line(s) 755, 756, 757, and 758 each encompass approximately the perimeter of the maps 751 through 754, wherein an offset from the boundaries of the floor surface has been maintained here for the purpose of illustration, as in the previous case.

A docking station 54 having a marker element 66 is stored in the map 751, along with a cleaning path 68 which starts and ends at this docking station 54 (bottom middle in FIG. 3E).

A docking station 54 having a marker element 66, and a cleaning path 68, which starts and ends at this docking station 54 (in the center in FIG. 3E), are stored in the map 752.

The two aforementioned docking stations 54 with respective marker element 66 are stored in the map 753, as well as a cleaning path 68 which starts at a marker element 66 and ends at the other marker element 66.

The centrally shown docking station 54 and another docking station 54 (top left) with respective marker element 66 are stored in the map 754, along with a cleaning path 68 which starts at a marker element 66 and ends at the other marker element 66. The last-mentioned cleaning path 68 is preferably also stored in the maps 752 and 753, associated with the central docking station 54 with marker element 66.

It can be seen from FIG. 3E that the routes of the cleaning paths 68 can each run in a meandering manner, wherein two preferred directions of the meandering paths are provided here in particular, but non-restrictively.

The visible regions within at least two or more of the maps 751, 752, 753, and 754 partially overlap. The marker elements 66 of the docking stations 54 in the center and at the bottom in the middle are each stored in at least two maps 751, 752, 753, or 754 and can serve as reliable anchor points for the combination with the map 75.

Empty runs or transport runs between marker elements 66 can be indicated by a transport path 74, for example, and added to the cleaning task if cleaning is not required. This is shown in FIG. 3E by way of example by a transport path 74 extending between two docking stations 54 (in the center and at the bottom in the middle). The transport path 74 is preferably stored in the maps 751, 752, and 753.

With the floor cleaning apparatus 10 and the floor cleaning system 12, cleaning paths 68 can be linked to one another in a user-friendly manner in order to define cleaning tasks. This can be done in a user-friendly manner using the graphical user interface of the display unit 48 by selecting the desired cleaning paths 68. The assignment of the cleaning paths 68 in each case to a marker element 66 makes it easier for the user 70 to create the cleaning task by providing information about the start position and the end position of the respective cleaning path 68 on the marker element 66 or on another marker element 66.

The creation and the start of a cleaning task are explained below by way of example in particular with reference to FIGS. 4 through 7.

To create the cleaning task, the user 70 can call up on the display unit 48 an overview of the stored cleaning paths 68 using the symbols 72. It is possible to carry out a search for marker elements 66 and/or for cleaning paths 68, for example, by means of a text field 76, and thereby to filter the information stored in the storage unit 40.

It is understood that, advantageously, filtering in accordance with transport paths 74 can also be possible.

For example, each cleaning path 68 or transport path 74 has a characteristic distinctive designation. Whereas in FIG. 4 some cleaning paths 68 are labeled only as “path 1, 2, 3, 4,” FIG. 5 shows this by way of example by labels such as “Supermarket 1” or the like.

The respective symbol 72 can represent a miniature view of the cleaning path 68 or transport path 74, or the environment in which the cleaning path 68 or transport path 74 runs. In this way, the selection of the cleaning path 68 or transport path 74 is visually made easier for the user 70.

It is also conceivable to select a docking station 54 and at least one cleaning path 68 linked thereto via a stored map. Alternatively or additionally, it can be provided that the cleaning paths 68 be able to be selected directly in the map.

In the example in FIG. 4, the user 70 has filtered the list in accordance with the marker element 66, “Marker 1.” FIG. 5 depicts the related result. In the present example, three cleaning paths 68 are linked to the Marker 1, namely, “Supermarket 1,” “Supermarket 2,” and “Supermarket 3.” Furthermore, the transport paths 74, “Supermarket without cleaning” and “Transport,” were found.

By using the symbols 72, the user 70 selects the desired cleaning paths, in the present example, “Supermarket 1” and “Supermarket 2”, which are each marked in the order of their selection—numbers “1” and “2” in the respective symbol 72.

The selected marker element 66, “Marker 1,” and the last selected cleaning path 68 are also shown on the display unit 48, wherein “Path ID:23” corresponds to the cleaning path, “Supermarket 2.” By confirming on a button 78, the cleaning task comprising the two cleaning paths 68 can be stored and made available for processing. A selection of transport paths 74 is possible, alternatively or additionally.

It can be provided, for example, that, when a respective symbol 72 is selected, it be displayed whether the cleaning path 68 starts and/or ends at Marker 1. If the start position is different from the end position, the respective other marker element (the “Marker”) at which the start position or end position is located can be displayed. The above information can, for example, be a component of the image information of the symbol 72.

FIG. 5 shows on the bottom right a cleaning path 68 that cannot be selected after filtering the list. The corresponding symbol 72 is grayed out. The corresponding cleaning path 68 cannot be started from the marker element 66, “Marker 1,” or does not end at it. In this way, the user 70 is supported in creating the cleaning task.

Complex cleaning tasks can also be defined in a user-friendly manner with the device 10 in accordance with the invention and the system 12 in accordance with the invention. Preferably, it is not only possible to link cleaning paths 68 and transport paths 74 to one another starting from a marker element 66, but also, as explained, to link cleaning paths 68 and transport paths 74 to other marker elements 66. In this way, for example, several rooms and also several stories which can be reached via ramps, for example, can be linked to one another.

To initiate the cleaning task, the user 70 receives a notification on the display unit 48 to position the floor cleaning apparatus 10 in front of the marker element 66, “Marker 1” (FIG. 6). The aim is to detect the correct marker element 66 by means of the sensor unit 38 and to verify the position of the floor cleaning apparatus 10. The detection of the marker element 66 is made visible for the user 70 on the display unit 48, as shown on the right in FIG. 7. By actuating a button 78, the cleaning task can be started.

The possibility of using docking stations 54 can be taken into account in the processing and/or planning of cleaning paths 68. For example, before processing or after processing a cleaning path 68, a consumable component is supplied, or a used component is discharged. If, while processing the cleaning task, the floor cleaning apparatus 10 determines that the resources are insufficient, a nearby docking station 54, for example, can be approached in order to supply the consumable component and, if necessary, to discharge a used component.

The cleaning paths 68 and transport paths 74 can, for example, be defined externally and transmitted to the storage unit 40.

The floor cleaning apparatus 10 is conveniently operable in a teach-in operating mode. The user 70 can guide the floor cleaning apparatus 10 over the floor surface 14 to define a respective cleaning path 68. The route is stored, and, also, information on which cleaning unit 22 is activated in each case. The same applies to transport paths 74.

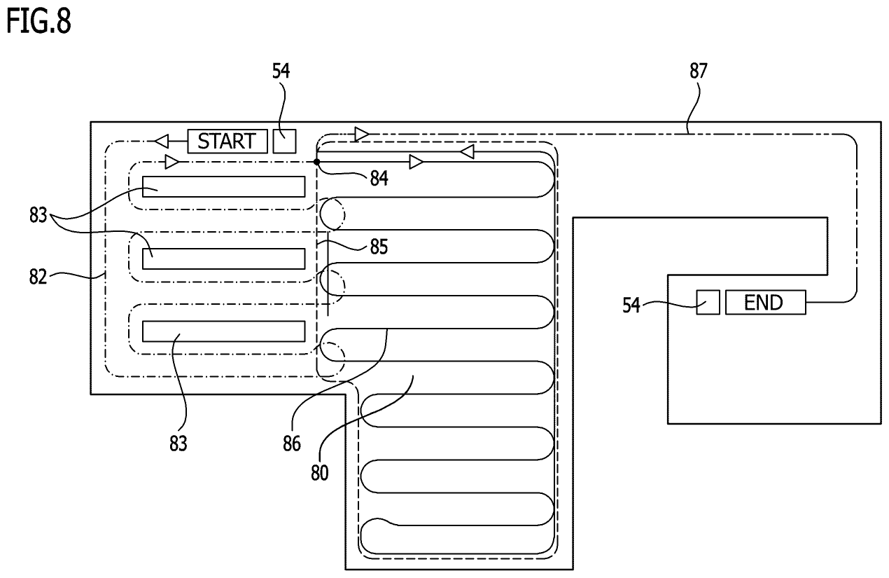

With the floor cleaning apparatus 10, it is provided that a route be able to automatically be assigned to sections 80 of the floor surface 14 in order to clean as much of the surface as possible. This will be discussed below with reference to FIGS. 8 through 10.

FIG. 8 schematically shows the teach-in process of a cleaning path 68 starting from a first docking station 54.

First, the floor cleaning apparatus 10 is guided by the user 70 along a segment 82 between obstacles 83. If the user 70 reaches section 80 at point 84, which represents a free area of the floor surface 14, the user 70 moves the floor cleaning apparatus 10 along a segment 85 along the perimeter of the section 80.

Back at the point 84, the floor cleaning device 10 automatically fills the section 80 with a travel path 86 for processing all the surface of the section 80. This route 86 is used as a basis for subsequently processing the cleaning path 68.

Starting from the point 84, the user 70 guides the floor cleaning apparatus 10 along a segment 87 up to a second docking station 54, at which the cleaning path 68 ends.

With the floor cleaning apparatus 10, there is accordingly the possibility of combining segments 82, 87, which are completely predefined by the user 70, with segments 85 created automatically or semi-automatically within a cleaning path 68.

It can be provided that the floor cleaning apparatus 10 detect sections 80 of the floor surface 14 by the sensor unit 38, which sections can be automatically assigned a route 86, and provide the user 70 with a notification of this on the display unit 48. After confirmation by the user 70, the route over the section 80 can be defined by the floor cleaning apparatus 10.

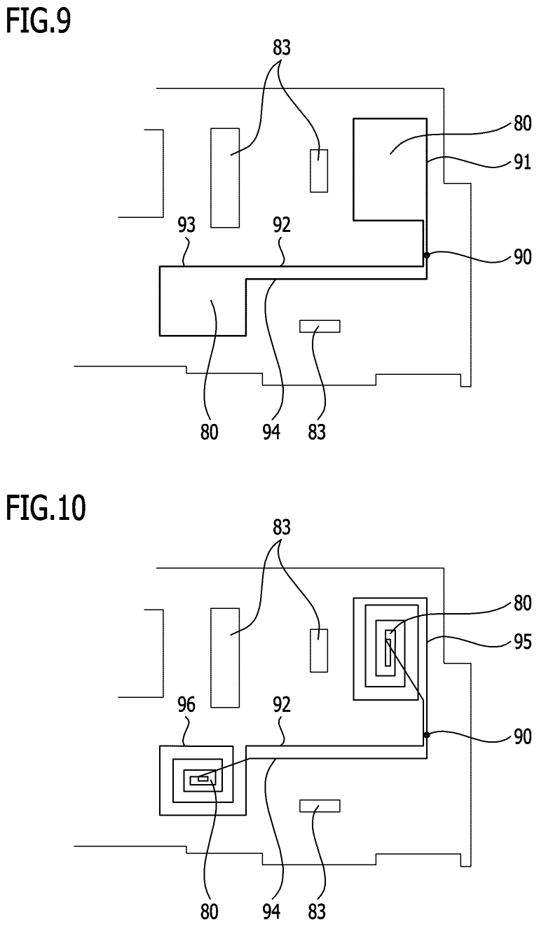

In the example in FIG. 9, the user 70 starts at a start position 90 and circles a section 80 of the floor surface 14 (segment 91). Subsequently, the user 70 moves along a segment 92 to another section 80 of the floor surface 14, which he circles with a segment 93. Subsequently, the user 70 moves along a segment 94 to an end position, in the present case, the start position 90.

The segments 91 and 93 encompassing the sections 80 are recognized by the floor cleaning apparatus 10 as free areas and can be automatically assigned routes 95 and 96, as shown in FIG. 10. Alternatively, the user 70 can trigger the assignment of the sections 80 with the routes 95, 96. A cleaning of sections 80 is achieved in each case. The routes 95, 96 are stored in the cleaning path 68 for later processing.

It can be provided that, when a marker element 66 is detected when the floor cleaning apparatus 10 is moved by the user 70 over the floor surface 14, information about cleaning paths 68 be automatically displayed on the display unit 48 which is associated with this marker element 66.

With the floor cleaning system 120 shown in FIG. 11, a display unit 98 and a storage unit 100 are provided spatially apart from the floor cleaning apparatus 10. The display unit 98 is shown, by way of example, as a display unit 98 of a data processing device 102, which may be a cloud service, for example. The data processing device 102 further comprises the storage unit 100.

Image information can be transmitted from the floor cleaning apparatus 10 via the communications unit 42 for display on the display unit 98. For example, the cleaning task can be created using the data processing device 102. It is also possible to create cleaning paths 68 and transport paths 74 using the data processing device 102.

In particular, the information about the landmarks 64 and, associated therewith, cleaning paths 68 can be stored in the storage unit 100. Data relating to this can be transmitted by the communications unit 42 to the floor cleaning apparatus 10. Conversely, information can be stored by the floor cleaning apparatus 10 in the storage unit 100.

The use of an external storage unit 100 makes it possible to use a plurality of floor cleaning apparatuses for cleaning tasks in a user-friendly manner, without data having here to be transmitted between the storage units 40 of the floor cleaning apparatuses.

List of reference numerals:

| | |
|---|---|
| 10 | Floor cleaning apparatus |
| 12, 120 | Floor cleaning system |
| 14 | Floor surface |
| 16 | Housing |
| 18 | Running gear |
| 20 | Control unit |
| 22 | Cleaning unit |
| 24 | Floor cleaning head |
| 26 | Side brushes |
| 28 | Suction strip |
| 30 | Suction unit |
| 32 | Reservoir |
| 34 | Dirty-liquid tank |
| 36 | Battery |
| 38 | Sensor unit |
| 40 | Storage unit |
| 42 | Communications unit |
| 44 | Control unit |
| 46 | Forward direction |
| 48 | Display unit |
| 50 | Dashed line |
| 52 | Touchscreen |
| 54 | Docking station |
| 56 | Map |
| 561, 562, 564, 565 | Map |
| 563 | Combined map |
| 566 | Dashed line |
| 58, 59, 60, 61, 62, 63 | Connection element |
| 64 | Landmark |
| 66 | Marker element |
| 68 | Cleaning path |
| 70 | User |
| 72 | Symbol |
| 74 | Transport path |
| 75 | Combined map |
| 751, 752, 753, 754 | Map |
| 755, 756, 757, 758 | Line |
| 76 | Text field |
| 78 | Button |
| 80 | Section |
| 82, 85, 87, 91, 92, 93, 94 | Segment |
| 86, 95, 96 | Route |
| 83 | Obstacle |
| 84 | Point |
| 90 | Start position |
| 98 | Display unit |
| 100 | Storage unit |
| 102 | Data processing device |

1. Floor cleaning system comprising a self-propelled and self-steering floor cleaning apparatus,
at least one controllable display unit
and at least one storage unit,
wherein the floor cleaning apparatus comprises a running gear for traveling on a floor surface, a control unit, a sensor unit, at least one cleaning unit, and an operating unit,
wherein an environment is detectable by means of the sensor unit in order to locate and/or navigate the floor cleaning apparatus, in particular during movement,
wherein cleaning paths for the floor cleaning apparatus are stored in the at least one storage unit with respective information about a route and preferably the use of at least one cleaning unit,
wherein a cleaning task is specifiable by a user on the operating unit by linking two or more cleaning paths to be processed successively, and the cleaning task is automatically processable by the floor cleaning apparatus,
wherein at least one characteristic landmark that is detectable by means of the sensor unit is stored in the storage unit and is associated with two or more cleaning paths,
wherein a start position and/or an end position of a respective cleaning path is located on or at the landmark,
and wherein a selection of the cleaning paths associated with the respective landmark is providable to the user on the at least one display unit.

2. Floor cleaning system in accordance with claim 1, wherein two or more characteristic landmarks detectable by means of the sensor unit are stored in the storage unit,
wherein two or more cleaning paths are associated with at least one landmark.

3. Floor cleaning system in accordance with claim 1 or 2, comprising at least one landmark which is preferably configured as a marker element which is visually and/or electrically and/or electromagnetically detectable by the sensor unit, wherein the marker element is in particular a matrix code or a barcode.

4. Floor cleaning system in accordance with one of the preceding claims, wherein at least one characteristic feature of an environment of the floor cleaning apparatus is usable as a landmark.

5. Floor cleaning system in accordance with one of the preceding claims, wherein the cleaning task is storable in the at least one storage unit.

6. Floor cleaning system in accordance with one of the preceding claims, wherein a map of the environment, in which the cleaning paths associated with the landmark are stored, is stored in the storage unit associated with at least one landmark.

7. Floor cleaning system in accordance with one of the preceding claims, wherein a combined map, in which the at least one landmark and the cleaning paths associated with these landmarks are stored, is stored in the storage unit.

8. Floor cleaning system in accordance with one of the preceding claims, wherein cleaning paths are provided and associated with the at least one landmark which have a start position and their end position at the landmark, and/or cleaning paths are provided which have a start position at one landmark and an end position at another landmark.

9. Floor cleaning system in accordance with one of the preceding claims, wherein the floor cleaning apparatus is hand-guided by a user, in particular, wherein at least one of the following applies:
the floor cleaning apparatus is guidable by the user from a current start position to a landmark, starting from which the cleaning task is initiated;
the floor cleaning apparatus is guidable by the user from a landmark to a parking position after completion of the cleaning task;
the floor cleaning apparatus is guidable by the user from a first landmark at which a cleaning path ends up to another landmark at which another cleaning path begins.

10. Floor cleaning system in accordance with one of the preceding claims, wherein, in the at least one storage unit, at least one transport path is stored linked to at least one landmark without using the at least one cleaning unit, which landmark is specifiable by the user in particular as a component of the cleaning task.

11. Floor cleaning system in accordance with one of the preceding claims, wherein at least one of the following applies:
a graphical user interface is providable to the user on the display unit for seeking a stored landmark and/or a stored cleaning path;
a map of the environment is displayable to the user on the display unit for selecting a landmark shown therein and/or a stored cleaning path.

12. Floor cleaning system in accordance with one of the preceding claims, wherein a graphical user interface is providable to the user on the display unit for showing information relating to a landmark and/or a stored cleaning path, in particular, depending upon a preceding search and/or selection in a map.

13. Floor cleaning system in accordance with one of the preceding claims, wherein cleaning paths are selectable on the user interface using names and/or symbols and are displayable in a manner linkable to the cleaning task.

14. Floor cleaning system in accordance with one of the preceding claims, wherein the cleaning paths are displayable linked to a selected landmark, in particular, cleaning paths that are not associated with the landmark are hidden or are displayed as non-selectable.

15. Floor cleaning system in accordance with one of the preceding claims, wherein the at least one cleaning path is creatable by a user on a data processing device external to the floor cleaning apparatus and is storable in the at least one storage unit.

16. Floor cleaning system in accordance with one of the preceding claims, wherein the floor cleaning apparatus is designed and configured to create and store at least one cleaning path, under the guidance of the user, on the operating unit in a teach-in operating mode.

17. Floor cleaning system in accordance with claim 16, wherein a section of the floor surface recognized by the floor cleaning apparatus and/or a section of the floor surface traversed by the user along a circumference are automatically assignable a route of the cleaning path, in particular, so as to cover the entire area.

18. Floor cleaning system in accordance with one of the preceding claims, wherein a notification is providable to the user, in particular, on the at least one display unit, as to the quantity of a consumable component required to clean the section, and/or whether the quantity of an existing consumable component carried by the floor cleaning appliance is sufficient to clean the section.

19. Floor cleaning system in accordance with one of the preceding claims, wherein the cleaning path is adapted to have one or more segments, wherein at least one cleaning unit is activated on at least one segment, wherein at least one of the following applies to the cleaning path:
different types of cleaning units are activated or deactivated at different segments of the cleaning path or within a respective segment;
there is at least one segment in which no cleaning unit is activated;
paths and assignable sections of the floor surface are stored in the cleaning path;
at least one interaction event of the floor cleaning apparatus with the environment is stored in the cleaning path, in particular, an acoustic and/or visual notification to be output by the floor cleaning apparatus.

20. Floor cleaning system in accordance with one of the preceding claims, wherein a notification is outputtable to the user on the at least one display unit to recognizably position the floor cleaning apparatus at a landmark by means of the sensor unit.

21. Floor cleaning system in accordance with one of the preceding claims, wherein at least one of the following applies in the event of the detection of at least one landmark:
information about the cleaning paths associated therewith is displayable on the display unit, preferably for creating the cleaning task;
the processing of a cleaning task beginning at the landmark is triggerable.

22. Floor cleaning system in accordance with one of the preceding claims, wherein, when the floor cleaning apparatus is guided by the user, a notification about the cleaning paths associated with the landmark is providable on the display unit when the at least one landmark is detected by the sensor unit.

23. Floor cleaning system in accordance with one of the preceding claims, wherein the floor cleaning system comprises at least one docking station for the floor cleaning apparatus for assuming a defined position in a docking position, wherein the at least one docking station preferably comprises or forms a landmark.

24. Floor cleaning system in accordance with claim 23, wherein the floor cleaning apparatus is suppliable, via the at least one docking station, with a consumable component required for processing the cleaning task, and/or a used component of the floor cleaning appliance is able to be picked up.

25. Floor cleaning system in accordance with claim 23 or 24, wherein the floor cleaning apparatus is designed such that, at a respective docking station, at least one usable component is supplied in a sufficient amount for an upcoming cleaning path, and/or a used component is removed.

26. Floor cleaning system in accordance with one of claims 23 to 25, wherein the floor cleaning apparatus is designed such that, during the processing of the cleaning task, the at least one docking station is visitable in the event that the processing requires the supply of at least one consumable component and/or the discharge of at least one used component.

27. Floor cleaning system in accordance with one of claims 23 to 26, wherein the at least one docking station is headable for in the cleaning path in accordance with a specification, in order to supply at least one consumable component and/or to discharge at least one used component.

28. Floor cleaning system in accordance with one of claims 23 to 27, wherein the floor cleaning apparatus is designed such that, during the processing of the cleaning task, depending upon a remainder of the cleaning task still to be processed, it automatically determines an amount of a consumable component required for this purpose and, if necessary, picks it up at at least one docking station and/or discharges a consumed component, wherein picking up too much consumable component is preferably avoided.

29. Floor cleaning system in accordance with one of the preceding claims, wherein the floor cleaning apparatus comprises at least one storage unit.

30. Floor cleaning system in accordance with one of the preceding claims, wherein at least one storage unit is positioned remote from the floor cleaning apparatus, wherein information that is to be stored or is stored is transmittable from the floor cleaning apparatus to the storage unit and/or vice versa via a communications unit, in particular, wherein the floor cleaning system comprises a data processing device which has the storage unit.

31. Floor cleaning system in accordance with one of the preceding claims, wherein the floor cleaning apparatus comprises at least one display unit.

32. Floor cleaning system in accordance with one of the preceding claims, wherein at least one display unit is positioned remote from the floor cleaning apparatus, wherein image information is transmittable from the floor cleaning apparatus to the display unit via a communications unit, in particular, wherein the floor cleaning system comprises a data processing device which has the display unit.

33. Floor cleaning apparatus of a floor cleaning system in accordance with the invention, in accordance with one of the preceding claims.

34. Method for operating a floor cleaning system in accordance with one of claims 1 to 32 or a floor cleaning apparatus in accordance with claim 33, wherein at least one characteristic landmark is stored in the storage unit, to which landmark are associated two or more cleaning paths, wherein a start position and/or an end position of a respective cleaning path is located on or at the landmark, and wherein a cleaning task is specified by a user on the operating unit by linking two or more cleaning paths to be processed successively, and the cleaning task is automatically processed by the floor cleaning apparatus.
